(19) United States
(12) Patent Application Publication
(10) Pub. No.: US 2010/0224694 A1
(43) Pub. Date: Sep. 9, 2010

(54) METHOD FOR REDUCING OR CLAMING HURRICANES AND/OR OTHER STORMS AND FOR CIRCULATING WATER

(76) Inventors: Douglass B. Wright, SR., Bloomfield, CT (US); Douglass B. Wright, JR., Miami, FL (US)

Correspondence Address: MICHAUD-Kinney Group LLP, 306 INDUSTRIAL PARK ROAD, SUITE 206, MIDDLETOWN, CT, 06457, US

(21) Appl. No.: 12/280,860

(22) PCT Filed: Sep. 7, 2007
(86) PCT No.: PCT/US07/19622

§ 371 Date: Aug. 27, 2008

Related U.S. Application Data
(60) Provisional application No. 60/843,023, filed on Sep. 7, 2006.
(60) Provisional application No. 60/904,160, filed on Feb. 28, 2007.

(51) Int. Cl. A01G 15/00; F04B 17/02

(52) U.S. Cl. 239/2.1; 417/53

(57) ABSTRACT

A storm may be calmed by cooling the surface of a body of non-stagnant water when the storm passes over that body of water. Optionally, the water may be cooled by circulating the water to bring cool water up from below the surface to cool the surface water. Optionally, the wind of the storm may be used to provide power to drive a pump to circulate the water. Alternatively, a liquid in a container may be mixed by placing a wind-powered pump in the container and exposing the pump to wind.

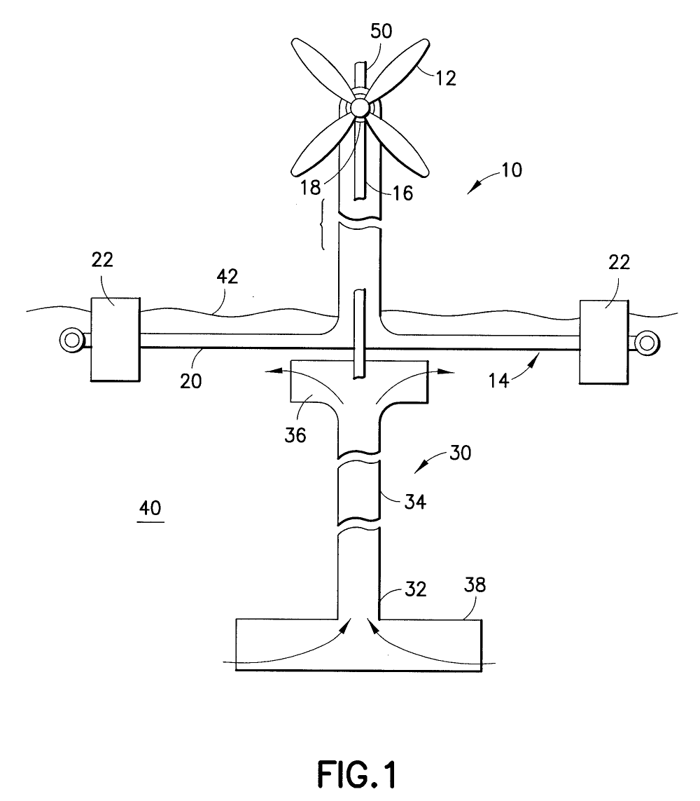

### CROSS REFERENCE TO RELATED APPLICATIONS

This application claims the benefits of U.S. Provisional Application No. 60/843,023 filed on Sep. 7, 2006 and U.S. Provisional Application No. 60/904,160 filed on Feb. 28, 2007, the contents of which are herein incorporated by reference in their entirety.

### BACKGROUND

As modern societies invest more and more resources into roads, buildings and various infrastructure projects, the threat of damage that may be caused by storms increases. Severe storms, such as Katrina, which hit the southeastern United States in 2005, can cause damage so severe that the population of the affected area has to be evacuated for extended periods of time and the costs of rebuilding can have a significant societal impact. Since an increase in the number and severity of storms is expected, there is a need for a way to reduce the severity of storms that threaten populated areas.

The severity of a storm can be reduced by cooling the air in the storm system. When a storm passes over a large, cool body of water, the water cools the air of the storm system and takes energy out of the storm, thus reducing its intensity.

### SUMMARY

A method for calming a storm comprises cooling the surface of a body of non-stagnant water when the storm passes over that body of water.

According to one aspect, the method may comprise circulating the water in the body of non-stagnant water to bring cool water up from below the surface to cool the surface water.

According to another aspect, the method may comprise using the wind of the storm to provide power to drive a pump to circulate the water.

In an alternative embodiment, a method for mixing a liquid in a container comprises placing a wind-powered pump in the container and exposing the pump to wind.

### BRIEF DESCRIPTION OF THE FIGURE

The sole FIGURE is a schematic cross-sectional view of a device useful for practicing the method described herein.

### DETAILED DESCRIPTION OF THE INVENTION

The severity of a storm passing over a body of water can be reduced by cooling the surface of a body of water over which the storm passes. In one embodiment, this may be accomplished by circulating the water in the body of water so that cool water from a stratum below the surface of the water is circulated upward to the surface while the storm system is above the water. As a result, the surface of the water is even cooler than it would otherwise be, and the presence of the storm over the water calms the storm more than it would otherwise. This method may be applied to storms over small, stagnant bodies of water, such as ponds, lakes, etc., and large or non-stagnant bodies such as oceans, seas, rivers, etc. In one example, this method is applied to the waters off the Northwest Coast of Africa, known by some as the “Hump”, which waters have an important effect on the spawning of hurricanes that continue on to impact the Caribbean Islands, Mexico and the Southern and Eastern Coasts of the United States. In this example, the method is practiced by lowering the temperature of the waters at that particular place 1° or 2° F., either by the device described herein or by iceberg or pipe to Antarctica or any other device.

Another way to calm a storm is to remove energy from the winds of the storm. This may be done by placing turbines in the path of the winds so that some of the energy of the wind is employed in driving the turbine. For a storm passing over a body of water, the turbine may be used to provide power for a pump that circulates the water to bring cooler water to the surface, which further calms the storm.

By calming a storm over a body of water as described herein, the storm can be expected to do less damage when it makes landfall than it would otherwise.

One example of a device useful for practicing the water-circulation method described herein is shown in the FIGURE. Device 10 comprises a wind turbine 12 mounted on a floating base 14 so that device 10 floats in the water 40. The wind turbine is connected to a drive shaft 16 by a gear box 18. Floating base 14 includes a peripheral frame 20 on which a plurality of floatation buoys 22 are mounted. Turbine 12 includes a tail fin 50 disposed at right angles to the face of turbine 12.

Device 10 also includes a circulation pump 30 having an inlet 32, an upwardly-extending conduit 34 and an outlet 36. Conduit 34 may be a pipe, a hose, or the like. Inside pump 30 is an impeller (not shown) for drawing water into inlet 32, up through conduit 34 and out outlet 36. The impeller is driven by drive shaft 16. Inlet 32 includes a filter 38 to prevent fish and/or debris from being drawn into the pump.

In use, device 10 is placed in a body of water over which a storm is passing. Floating base 14 is configured to that device 10 will float stably with pump 30 submerged in the water 40, preferably with outlet 36 beneath the surface 42, and with wind turbine 12 above the surface of the water. When a storm passes over the water 40, fin 50 points turbine 12 directly into the storm winds. The winds drive turbine 12, which in turn powers pump 30, causing cold water to circulate up from a lower portion of water 40 toward the surface. Very little power is needed to drive pump 30 when both the inlet 32 and the outlet 36 are submerged, because under such conditions the threshold pressure differential across the pump is very small.

As a result of the operation of device 10, the surface 42 of water 40 is cooler than it otherwise would be during the storm. The cooler water has a calming effect on the storm. In addition, the operation of turbine 12 draws energy from the storm winds, further calming the storm.

Device 10 is portable, and may easily be placed where needed, and removed when not needed. Optionally, device 10 may be anchored in place so that the storm winds do not move it from the desired position.

In one alternative embodiment, device 10 may be permanently mounted on the ground beneath a body of water, for example, on the ocean floor, river bed, etc. In such case, turbine 12 is rotatably mounted so that fin 50 can turn turbine 12 into the wind even though device 10 is floor-mounted.

In another alternative embodiment, pump 30 may be driven indirectly by turbine 12. For example, pump 30 may be an electric pump, and turbine 12 may charge a storage device (not shown) from which pump 30 draws electric power. Optionally, device 10 may include a solar panel to power pump 30 instead of, or in addition to, the wind turbine. In yet another alternative embodiment, the outlet of pump 30 may be above the surface of the water.

Device 10 may be employed for uses other than calming weather. For example, such a device may be placed in a container of any liquid that needs mixing to homogenize its contents or to reduce thermal differentials in the liquid. Device 10 will therefore find use in chemical plants, water treatment plants, etc.

The practice of the method for calming storms is not limited to the use of the devices described herein. Any suitable mechanism for circulating water in a body of water to cool the water surface and thus calm the storm may be employed. As indicated above, water may be cooled for purposes of this invention by transporting an iceberg into the water from colder climes where icebergs exist naturally. In another embodiment, cold water from the Artic or from Antarctica may be pumped to the waters to be cooled (e.g., to waters off the Hump of Africa) via a pipeline.

The terms “a” and “an” herein do not denote a limitation of quantity, but rather denote the presence of at least one of the referenced item.

1-2. (canceled)

3. A method for calming a storm, comprising:
cooling the surface of a body of non-stagnant water when the storm passes over that body of water;
wherein cooling the surface of the body of non-stagnant water comprises using the wind of the storm to provide power to drive a pump to circulate the water.

4. The method of claim 3, wherein the non-stagnant water is the ocean at the hump of West Africa.

5. A method for calming a storm, comprising:
cooling the surface of a body of non-stagnant water when the storm passes over that body of water;
wherein cooling the surface of the body of non-stagnant water comprises transporting an iceberg into the water.

6. A method for calming a storm, comprising:
cooling the surface of a body of non-stagnant water when the storm passes over that body of water;
wherein cooling the surface of the body of non-stagnant water comprises piping water from Antarctica.

7. A method for mixing a liquid in a container, comprising placing a wind-powered pump in the container and exposing the pump to wind.

8. The method of claim 3, wherein cooling the surface of the body of non-stagnant water comprises circulating the water in the body of non-stagnant water to bring cool water up from below the surface to cool the surface water.
